(19) United States
(12) Patent Application Publication
(10) Pub. No.: US 2010/0290900 A1
(43) Pub. Date: Nov. 18, 2010

(54) HYDROPOWER SYSTEM WITH INCREASED POWER INPUT CHARACTERISTICS

(76) Inventor: Wayne Krouse, Houston, TX (US)

Correspondence Address: JAMES D. PETRUZZI, 4900 WOODWAY SUITE 745, HOUSTON, TX, 77056, US

(21) Appl. No.: 12/781,522

(22) Filed: May 17, 2010

Related U.S. Application Data
(60) Provisional application No. 61/178,982, filed on May 17, 2009.

(51) Int. Cl. F03B 13/00

(52) U.S. Cl. 415/182.1

(57) ABSTRACT

A turbine system having a series of uprights or fingers disposed about the inner surface of a rotating ring having turbine blades disposed within the ring. As the turbine blades are motivated by water movement, the fingers or uprights cause increased power by increasing the flow characteristics of the turbine system. The uprights can be of a variety of lengths and may be directed toward the central hub of the turbine or pointed at angles to the hub. Alternatively, the uprights may be bent on the end or curved to create a vortex into the main turbine blades.

### CROSS REFERENCE TO RELATED APPLICATIONS

This application claims the benefit of U.S. Provisional Application No. 61/178,982, filed 17 May 2009, titled “Variable Frequency Devices, Increased Power Inputs, and Autocleaning Debris Deflector”

### BACKGROUND OF THE INVENTION

1. Field of the Invention

The present invention relates to systems that generate power. In particular, the present invention relates to a hydropower system with increased power input characteristic.

2. Description of Related Art

As fluid is funneled towards impeller blades, present day turbine applications employ a variety of mechanisms to increase their effectiveness including, modifying static elements, rotating elements, or major upstream or downstream civil works alterations, all of which require major costs and extended shutdowns periods. Each of these mechanisms act to supply additional fluid towards impellers. Unfortunately, numerous mechanisms require adding additional components to turbine, modifying the shapes of the turbine along with the shape of the impeller. Thus, there exists a need for an application which can increase the available power from a rotating assembly, which allows for fluid flow to be added to fluid flow and additional head on to the current fluid mechanism.

### BRIEF DESCRIPTION OF THE DRAWINGS

The novel features believed to be characteristic of the invention are set forth in the appended claims. However, the invention itself, as well as a preferred mode of use and further objectives and advantages thereof, will best be understood by reference to the following detailed description when read in conjunction with the accompanying drawings, wherein:

FIG. 1 illustrates a perspective view of a system for power generation through movement of fluid.

FIG. 2 illustrates a side view system for power generation of a which is included in system for power generation as illustrated in FIG. 1 along line 2.

FIG. 3 illustrates an alternative embodiment of the system for power generation through movement of fluid illustrated in FIGS. 1 and 2.

FIG. 4 illustrates an alternative embodiment of the system for power generation through movement of fluid illustrated in FIGS. 1,2, and 3.

### DETAILED DESCRIPTION OF THE PREFERRED EMBODIMENTS

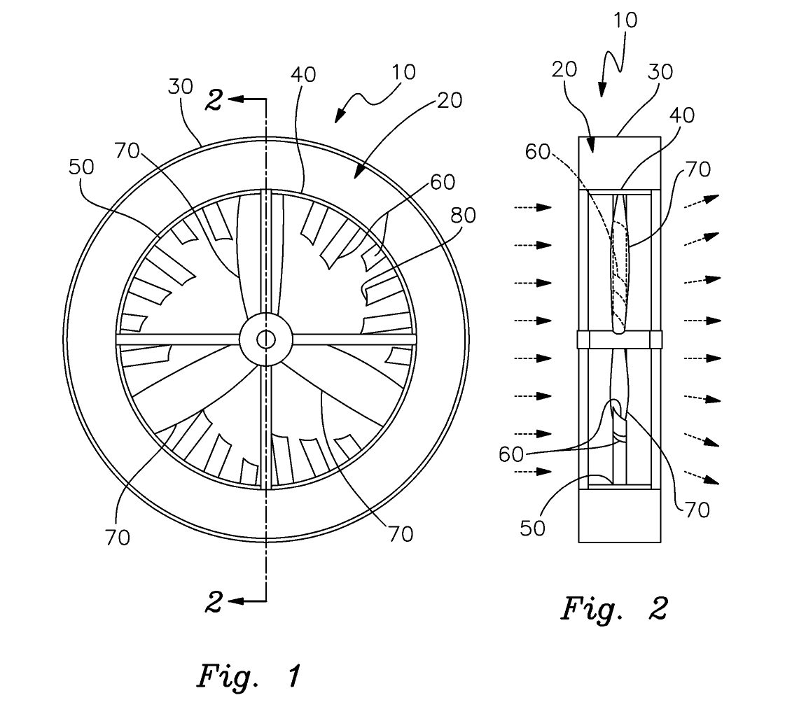

Referring now to the Figures, FIG. 1 and FIG. 2 illustrate a turbine system 10 which includes a generally cylindrical housing 20. Rotating ring 50 is caused to rotate circumferentially by impeller 70. One or more uprights 60 circumferentially disposed about spacing between impellers 70 and of a length less than the radius of said, ring 50. Uprights 60 increase fluid communication and act as additional impellers to further increase power generation as ring for rotating 50 translates about cylindrical housing 20. Uprights 60 extend like fingers from rotating ring 50 along with impellers 70 in order to allow fluid to cause a greater energy extraction as it is transmitted through turbine system for 10.

In an exemplary embodiment of the present application, turbine system 10 can include one or more uprights 60 positioned in an orientation substantially parallel in the same plane to one or more impellers 70 to effectuate a flow regime.

In an alternative embodiment of the present application, turbine system 10 may include one or more uprights 60 which are of varying lengths. For example, uprights 60 may individually extend to a non-uniform orientation relative to one another. One upright 60 may extend to a specified length, while another upright 60 may extend to another length, while still another upright 60 extends to yet another length.

Portions of uprights 60 may form various shapes, and may act to influence fluid disposed towards impellers 70. For example, as is illustrated in FIG. 1, ends of uprights 60 include concave tip portions 80 which increasingly extend in series ordered in a clockwise fashion. In an alternative embodiment, tips of uprights 60 may be fashioned in a generally rounded manner as they extend in series in a clockwise fashion. In yet another embodiment, uprights 60 can extend in a generally uniform fashion relative to impellers 70. For example, each of uprights 60 may be of uniform lengths while being evenly spaced relative to one another as they extend from cylindrical housing 20.

By positioning uprights 60 relative to impellers 70 various goals can be achieved. For example, in certain embodiments, uprights 60 may be positioned behind impellers 70 so that additional fluid pressure can build and in turn to supply further as fluid is communicated through turbine system 10. Similarly, uprights 60 can be disposed in front of impellers 70 in order to allow for added rotation of fluid, orthogonally, or nearly so, as fluid contacts turbine blade to generate the transfer of energy through turbine system 10.

Further, uprights 60 may be of various shapes and sizes. In certain embodiments, uprights 60 may be positioned in a fashion such that they are substantially flexible to allow for fluid to be transmitted in an orientation towards impellers 70. In another embodiment, uprights 60 may be substantially rigid such that fluid is deflected towards the orientation of fluids. In certain embodiments, uprights 60 may positioned in a direction in an angle positioned less than less than ninety degrees. In other embodiments uprights 60 may be of varying angles and of varying orientations.

Uprights 60 may initially extend at a ninety degree orientation relative to cylindrical housing 20 and as they extend towards center of turbine system 10, begin to taper to lesser degrees. Such a scenario is optimal when additional fluid is being naturally transmitted towards turbine system 10 in a non uniform fashion. For example, if fluid was naturally travelling in a non-laminar flow and a higher degree of fluid was being transmitted towards center of turbine system 10 and an upright 60 extending at initially ninety degrees (as is shown) was incapable taking optimal advantage of received fluid energy, another portion of upright 60 could beding to curve between twenty and sixty degrees in order to be placed in contact with an optimal amount of fluid energy.

In certain embodiments, one or more uprights 60 are circumferentially disposed about an inner diameter of a turbine input and extend about the diameter of a turbine. The turbine may be of the type with a static shrouding or may include a rotating apparatus.

In yet other embodiments, uprights 60 may extend from impellers 70 in a pattern that allows for a swirl to be created as fluid is transmitted through turbine system 10. Uprights 60 may extend from impellers 70 in an outwardly extending fashion. For example, in certain embodiments impellers 70 may increase in length as they extend outward from uprights 60. If only three impellers are employed, as each impeller 70 extends towards rotating ring 50, additional space between impellers becomes available. Thus, numerous uprights 60 may extend from each impeller 70 and may increase in length as additional space becomes available, In certain embodiments, although only a limited numbers of impellers may be employed, each upright 60 may extend from each impeller 70 to the same length.

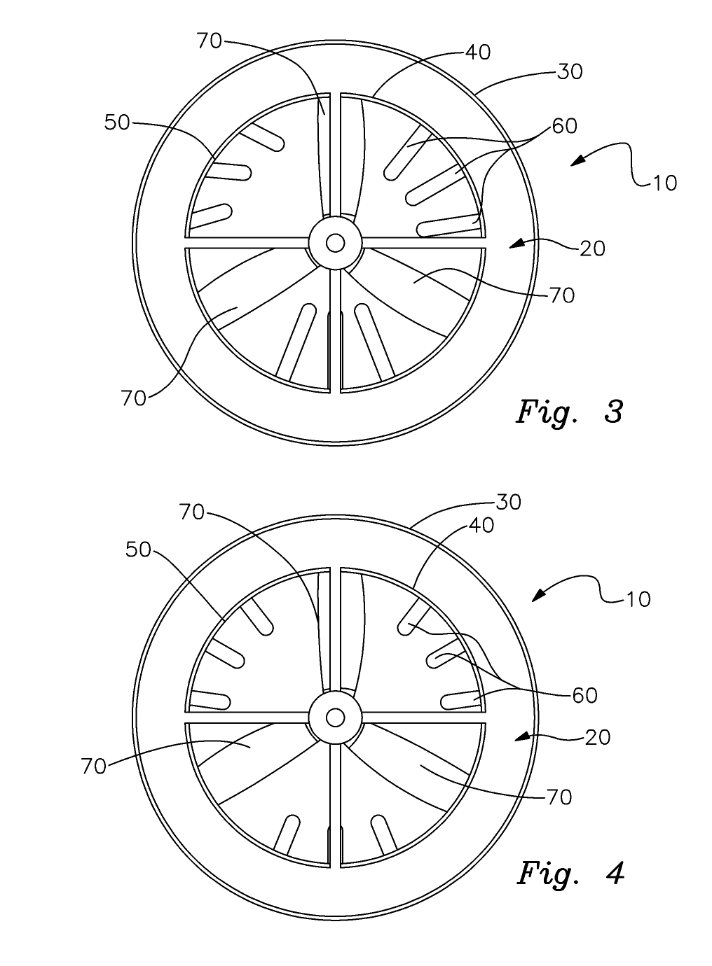

FIG. 3 and FIG. 4 illustrate exemplary alternative embodiments of turbine system 10. Ring for rotating 50 includes uprights 60 circumferentially disposed about inside surface 40 while impellers 70 are operably coupled to ring for rotating 50. Uprights 60 extend from inside surface 40 and rotate in unison with impellers 70. Uprights 60 illustrated in FIG. 3, extend to variable lengths and are positioned at various angles to allow fluid to increase power generation through movement of fluid. Several of uprights 60 are positioned at angles less than ninety degrees to allow for additional fluid load absorbtion. Each upright 60 need not necessarily extend to the same length as another upright 60 in certain embodiments, while in other embodiments, all uprights 60 can extend to the exact same length and be oriented at the exact same angle. As is shown in FIG. 4 uprights 60 are shown extending to approximately the same length at approximately ninety degrees in order to allow for fluid to allow for increased substantially uniform fluid absorption as fluid is communicated through turbine system 10. Additionally, uprights 60 can be located behind or in front of impellers 70 in order to attain a maximum amount of fluid absorbtion.

In a preferred embodiment, uprights 60 can extend about an inner diameter of a turbine and are oriented towards a direction of impeller 70 while being preferably positioned according to the direction of the flow. In certain embodiments, uprights 60 can tangentially extend about a turbine input at an angle which is substantially perpendicular to a turbine input. In other embodiments, some of uprights 60 may be oriented at an angle ranging between 0° and 180° and may extend towards the directional fluid flow or against the direction of a fluid flow and may be of variable flexibilities or multi-dimensional curvatures. In alternative embodiments, each of uprights 60 may extend at an orientation and height which does not necessarily extend to a same height and orientation as another of uprights 60.

In other embodiments, uprights 60 may extend to form various shapes and may extend to form a ninety degree angle such that an upright begins by extending substantially perpendicular to a turbine input and curves such that an end of upright 60 extends substantially parallel to the direction of fluid flow. In certain embodiments, uprights 60 may be fixably coupled to a turbine input, while in other embodiments uprights 60 may be removably coupled to a turbine input.

Each of uprights 60 may of a variable thickness, height, and width and extend to different lengths of said turbine or rotating ring for further increasing fluid flow into turbine impellers. In a preferred embodiment of the present application, uprights 60 are made of a semi-rigid material and allow for slight flexing. In other embodiments of the present application, uprights 60 can be comprised of a non-rigid material and in yet other embodiments of the present application, uprights 60 are comprised of a rigid material. In certain embodiments, several of uprights 60 may be made of a rigid material while other uprights 60 are made of a non-rigid material and yet other uprights 60 are made of a semi-rigid material.

In yet other embodiments, uprights 60 may be disposed above or below the surface of said rotating ring or said turbine shroud and makes into a length that is separate from said turbine impellers 70 between ranges of 0.0001 inches up to just less than the length of the turbine impellers 70.

In operation, as fluid begins to flow through a turbine input, uprights 60 cause a more efficient fluid flow through turbine impellers by channeling water further towards the direction of impellers 70 such that a greater amount of flow is exerted upon turbine impellers 70. Use of uprights decreases lost power generation due to water which escapes between the gaps of a turbine input and its corresponding separation from the impeller.

The components of system for power generation through movement of fluid and its various components may be made from a wide variety of materials. The system for generation of power through movement of fluid shown herein may also include various additional mechanisms including DC generators, AC Generators, asynchronous systems, synchronous systems, permanent magnets including rare earth magnets and the like. These materials making up system for power generation through movement of fluid may include metallic or non-metallic, magnetic or non-magnetic, elastomeric or non-elastomeric, malleable or non-malleable materials. Non-limiting examples of suitable materials include metals, plastics, polymers, wood, alloys, composites and the like. The metals may be selected from one or more metals, such as steel, stainless steel, aluminum, titanium, nickel, magnesium, or any other structural metal. Examples of plastics or polymers may include, but are not limited to, nylon, polyethylene (PE), polypropylene (PP), polyester (PE), polytetraflouroethylene (PTFE), acrylonitrile butadiene styrene (ABS), polyvinylchloride (PVC), polycarbonate, extruded organic thermosets such as polychloroprene and combinations thereof, among other plastics. The system for power generation through movement of fluid and its various components may be molded, sintered, machined and/or combinations thereof to form the required pieces for assembly.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of various embodiments, it will be apparent to those of skill in the art that other variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A system for power generation through movement of fluid comprising:
A generally cylindrical housing having an outside and inside surface;
A ring for rotating circumferentially disposed about the cylindrical housing;
One or more uprights circumferentially disposed about an inside surface of the cylindrical housing of a length less than the diameter of said inside surface of said housing; and
One or more impellers inside said ring operably coupled about the one or more uprights;
Wherein the one or more uprights increase fluid communication with the one or more impellers to further power generation as the ring for rotating translates about the cylindrical housing.

2. The system for power generation through movement of fluid of claim 1, wherein the one or more uprights are positioned in an orientation substantially parallel to the one or more impellers to effectuate a flow regime.

3. The system for power generation through movement of fluid of claim 1, wherein the one or more uprights are of varying lengths.

4. The system for power generation through movement of fluid of claim 1, wherein the one or more uprights are disposed behind the one or more impellers to impose added fluid pressure about the one or more impellers.

5. The system for power generation through movement of fluid of claim 1, wherein the one or more uprights extend to different lengths to impose a vortex about the one or more impellers.

6. The system for power generation through movement of fluid of claim 1, wherein the one or more uprights are curved.

7. A system for power generation through movement of fluid comprising:
A generally cylindrical housing;
A rotating ring disposed within the cylindrical housing;
One or more impellers operably coupled to the ring for rotating about the cylindrical housing; and
One or more fingers fixedly attached to said housing such that each finger is oriented generally inward towards the center of said housing.

8. The system for power generation through movement of fluid of claim 7, wherein the one or more uprights are positioned in an orientation substantially parallel to the one or more impellers to effectuate a flow regime.

9. The system for power generation through movement of fluid of claim 7, wherein the one or more uprights are of varying lengths.

10. The system for power generation through movement of fluid of claim 7, wherein the one or more uprights are disposed behind the one or more impellers to impose added fluid pressure about the one or more impellers.

11. The system for power generation through movement of fluid of claim 7, wherein the one or more uprights are semi-flexible.

12. A system for power generation through movement of fluid comprising:
A generally cylindrical housing;
A rotating ring disposed within the cylindrical housing;
One or more impellers operably coupled to the ring for rotating about the cylindrical housing; and
One or more fingers affixed on one end of said fingers to said housing and disposed at an angle less than ninety degrees from the surface of the generally cylindrical housing.

13. The system for power generation through movement of fluid of claim 12, wherein the one or more uprights are positioned in an orientation substantially parallel to the one or more impellers to effectuate a flow regime.

14. The system for power generation through movement of fluid of claim 12, wherein the one or more uprights are of varying lengths.

15. The system for power generation through movement of fluid of claim 12, wherein the one or more uprights are disposed behind the one or more impellers to impose added fluid pressure about the one or more impellers.

16. The system for power generation through movement of fluid of claim 12, wherein the one or more uprights extend to different lengths to impose a vortex about the one or more impellers.

17. The system for power generation through movement of fluid of claim 12, wherein the one or more uprights are semi-flexible.

18. The system for power generation through movement of fluid of claim 12, wherein: the generally cylindrical housing comprises a leading edge; and
at least one of the one or more fingers is positioned along the leading edge.

19. The system for power generation through movement of fluid of claim 12 wherein: the one or more fingers are equally disposed relative to one another about the rotating ring.

20. The system for power generation through movement of fluid of claim 12 wherein:
The one or more fingers extend to varying lengths relative to one another about the rotating ring.
